(19) United States
(12) Patent Application Publication
(10) Pub. No.: US 2023/0249184 A1
(43) Pub. Date: Aug. 10, 2023

(54) CHANNEL DESIGNS AND COMPONENTS

(71) Applicant: Sartorius Stedim Biotech GmbH, Göttingen (DE)

(72) Inventors: Samin Akbari, Winchester, MA (US); Thomas Kruse, Göttingen (DE); David Pollard, South Boston, MA (US); Markus Kampmann, Dortmund (DE)

(73) Assignee: Sartorius Stedim Biotech GmbH, Göttingen (DE)

(21) Appl. No.: 18/134,227

(22) Filed: Apr. 13, 2023

Related U.S. Application Data
(63) Continuation-in-part of application No. PCT/IB2021/000721, filed on Oct. 15, 2021.
(60) Provisional application No. 63/092,420, filed on Oct. 15, 2020.

(51) Int. Cl. B01L 3/00

(52) U.S. Cl. CPC B01L 3/502753; B01L 2300/0681; B01L 2200/0647; B01L 2200/027

(57) ABSTRACT

Fluidic modules configured for flowing fluid through membranes and associated methods are generally provided. In some embodiments, a fluidic module comprises two channels between which a membrane is positioned. The two channels may have geometries such that the pressure drop experienced by a fluid flowing from the first channel, through the membrane, and into the second channel is substantially independent of the location along the channel at which it flows through the membrane. In other words, the pressure drop may be substantially constant over the membrane area.

### RELATED APPLICATIONS

This application is a continuation in part of International Application No. PCT/IB2021/000721, filed Oct. 15, 2021, and entitled “Channel Designs and Components,” which claims priority under 35 U.S.C. § 119(e) to U.S. Provisional Application No. 63/092,420, filed Oct. 15, 2020, and entitled “Channel Designs and Components,” each of which is incorporated herein by reference in its entirety for all purposes.

### FIELD

Fluidic modules comprising channels separated by a membrane are generally described.

### BACKGROUND

In some fluidic devices, it is desirable to remove one or more components from a sample prior to performing further analysis. Such filtration often comprises flowing the sample through a membrane. However, many techniques for flowing samples through membranes result in premature and uneven fouling of the membranes.

Accordingly, new fluidic modules and methods for flowing samples through membranes would be advantageous.

### SUMMARY

The present disclosure generally describes fluidic modules and associated methods. The subject matter described herein involves, in some cases, interrelated products, alternative solutions to a particular problem, and/or a plurality of different uses of one or more systems and/or articles.

Some embodiments relate to fluidic modules. The fluidic module comprises a first channel comprising a first-channel inlet, a second channel comprising a second-channel outlet, and a membrane positioned between the first and second channels. The first and second channels are in fluidic communication with each other through the membrane. The fluidic module is configured such that fluid flowing from the first-channel inlet to the second-channel outlet experiences a substantially constant pressure drop over an area of the membrane. A dimension of the first channel perpendicular to the membrane decreases substantially monotonically from a portion of the channel proximal to the first-channel inlet to a portion of the channel distal from the first-channel inlet. A dimension of the second channel perpendicular to the membrane increases substantially monotonically from a portion of the channel distal to the second-channel outlet to a portion of the channel proximal to the second-channel outlet.

In some embodiments, a fluidic module comprises a first channel comprising a first-channel inlet and a first-channel outlet, a second channel comprising a second-channel outlet, and a membrane positioned between the first and second channels. The first and second channels are in fluidic communication with each other through the membrane. A dimension of the first channel perpendicular to the membrane decreases from a portion of the channel proximal to the first-channel inlet to a portion of the channel distal from the first-channel inlet. A dimension of the second channel perpendicular to the membrane increases from a portion of the channel distal to the second-channel outlet to a portion of the channel proximal to the second-channel outlet. The first-channel outlet is in fluidic communication with the first-channel inlet through a pathway other than the first channel.

Some embodiments relate to methods. The method comprises in a fluidic module comprising a first fluidic channel comprising a first-channel inlet, a second fluidic channel comprising a second-channel outlet, and a membrane, performing the step of: flowing a fluid through the fluidic module from the first-channel inlet, through the first channel, through the membrane, through the second channel, and out the second-channel outlet. The fluidic module comprises the first channel comprising the first-channel inlet, the membrane, and the second channel comprising the second-channel outlet. The membrane is positioned between the first and second channels. The fluid experiences a substantially constant pressure drop through the membrane over an area of the membrane. A dimension of the first channel perpendicular to the membrane decreases monotonically from a portion of the channel proximal to the first-channel inlet to a portion of the channel distal from the first-channel inlet. A dimension of the second channel perpendicular to the membrane increases monotonically from a portion of the channel distal to the second-channel outlet to a portion of the channel proximal to the second-channel outlet.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows one non-limiting embodiment of a fluidic module, in accordance with some embodiments;

FIG. 2 shows one non-limiting embodiment of a fluidic module comprising an inlet and an outlet, in accordance with some embodiments;

FIG. 3 shows one non-limiting embodiment of a fluidic module comprising an inlet and two outlets, in accordance with some embodiments;

FIGS. 4-9 show various examples of manners in which fluid may flow through a fluidic device, in accordance with some embodiments;

FIG. 10 shows a plot of flow rate in a top channel and a bottom channel in a fluidic module in which an inlet is positioned in the top channel and an outlet is positioned in the bottom channel and for which the flow through the membrane is constant across the membrane area, in accordance with some embodiments;

FIG. 11 shows a plot for two possible height profiles of a channel comprising an inlet and positioned above a channel comprising an outlet for two different sample volumes, in accordance with some embodiments;

FIG. 12 shows one non-limiting example of a fluidic module comprising top and bottom channels, in accordance with some embodiments;

FIG. 13 shows the pressures present in two channels and a membrane present in a fluidic module, in accordance with some embodiments;

FIG. 14 shows two exemplary height profiles for a channel comprising an inlet that is positioned above a channel comprising an outlet, in accordance with some embodiments;

FIG. 15 shows a schematic depiction of one non-limiting example of a fluidic device comprising three parallel fluidic modules, in accordance with some embodiments;

FIG. 16 shows a schematic depiction of one non-limiting example of a fluidic device comprising two fluidic modules, in accordance with some embodiments; and

FIG. 17 shows a schematic depiction of one non-limiting example of a fluidic device comprising two fluidic modules and a moat, in accordance with some embodiments.

### DETAILED DESCRIPTION

Fluidic modules configured for flowing fluid through membranes and associated methods are generally provided. In some embodiments, a fluidic module comprises two channels between which a membrane is positioned. The two channels may have geometries such that the pressure drop experienced by a fluid flowing from the first channel, through the membrane, and into the second channel is substantially independent of the location along the channel at which it flows through the membrane. In other words, the pressure drop may be substantially constant over the membrane area.

A substantially constant pressure drop over the membrane area may be advantageous because it may promote flow through the membrane that is substantially constant over the membrane area. This may cause each portion of the membrane to be used equally, which may cause the membrane to foul and/or become clogged in a relatively homogenous manner. By contrast, a pressure drop that varies over the membrane area may result in locations where the pressure drop is lower fouling first and clogging, which may cause premature membrane failure, reduced yield of purified sample, and/or reduced device performance.

In some embodiments, the shapes of the channels separated by the membrane cause the membrane to have a substantially constant pressure drop over its area. By way of example, a channel providing fluid to be filtered may have a dimension perpendicular to the membrane that decreases in the downstream direction and/or a channel receiving filtered fluid may have a dimension perpendicular to the membrane that increases in the downstream direction.

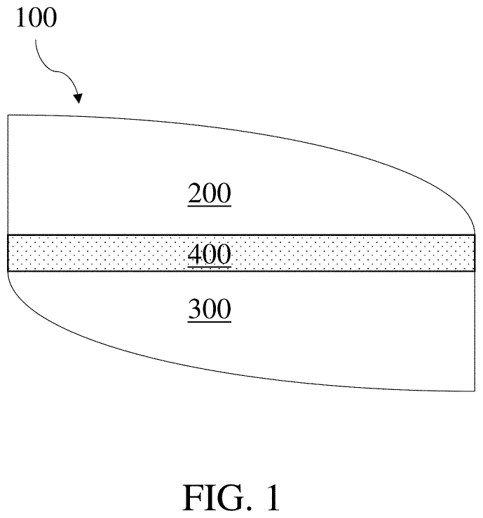

FIG. 1 shows one non-limiting embodiment of a fluidic module. In FIG. 1, the fluidic module 100 comprises a first channel 200, a second channel 300, and a membrane 400. In FIG. 1, the membrane 400 is disposed on the second channel 300 and the first channel 200 is disposed on the membrane 400. The first and second channels shown in FIG. 1 may be in fluidic communication with each other through the membrane. In other words, fluid may be able to flow from the first channel to the second channel (and/or the second channel to the first channel) through the membrane.

Components disposed on each other as described herein and/or shown in the figures herein may be directly disposed on each other or may be indirectly disposed on each other. In other words, as used herein, when a component is referred to as being “disposed on” or “adjacent” another component, it can be directly disposed on or adjacent the component, or it may be disposed on one or more intervening components disposed on the other component. A component that is “directly disposed on”, “directly adjacent” or “in contact with” another component means that it is disposed on the other component in a manner such that no intervening component is present.

As shown in FIG. 1, in some embodiments, a fluidic module comprises a first channel that is positioned above a second channel. However, other arrangements of channels are also possible. As one example, in some embodiments, a fluidic module comprises two channels that are positioned next to each other (e.g., a first channel that is positioned to the left of a second channel). As another example, a fluidic module may comprise two channels that are positioned such that the shortest line segment connecting their central axes includes both a vertical component and a horizontal component.

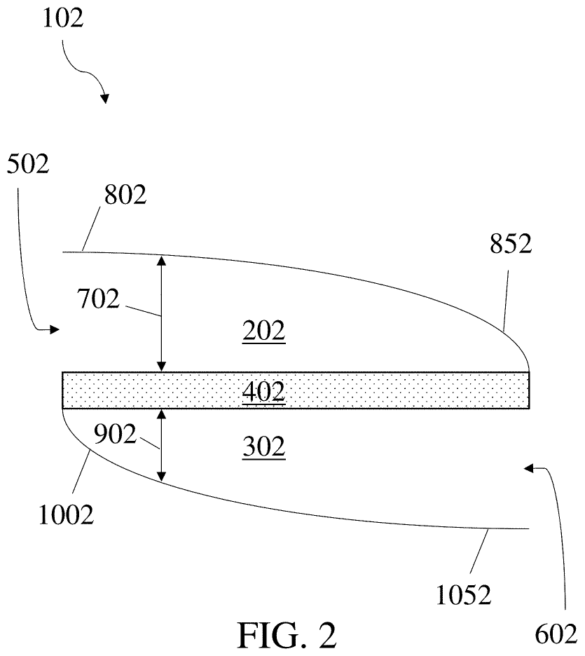

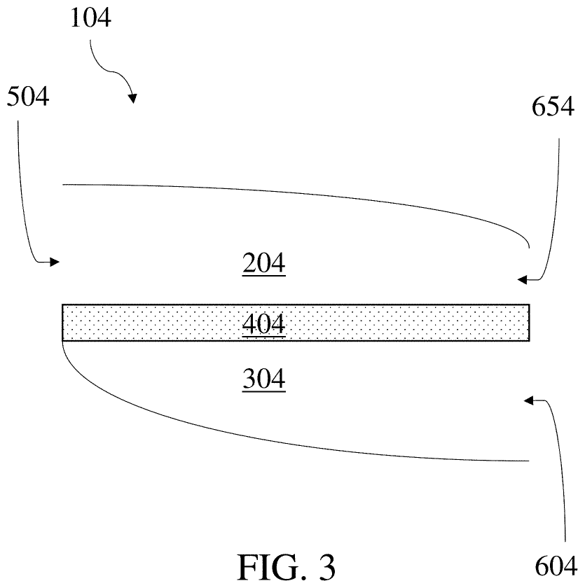

In some embodiments, a fluidic module comprises one or more channels that comprise an inlet and/or an outlet. For instance, with reference to FIG. 2, a fluidic module 102 may comprise a first channel 202 comprising an inlet 502. As also shown in FIG. 2, a fluidic module may also comprise a second channel 302 comprising an outlet 602. As another example, with reference to FIG. 3, a fluidic module 104 may comprise a first channel 204 comprising an inlet 504 and an outlet 654. As also shown in FIG. 3, a fluidic module may also comprise a second channel 304 comprising an outlet 604.

When a fluidic module comprises channels that comprise inlets and outlets, they may be arranged as shown in FIG. 2 or in FIG. 3 (i.e., a first channel comprising an inlet may be positioned above a second channel lacking an inlet) or may be arranged in another manner. For instance, in some embodiments, a first channel comprising an inlet is positioned below a second channel comprising an outlet. It is also possible for a first channel comprising an inlet to be positioned beside (e.g., to the left of, to the right of) a second channel comprising an outlet. As a third example, two channels may be positioned with respect to each other such that the shortest line segment connecting the central axes of the first channel comprising the inlet and the second channel lacking the inlet includes both a vertical component and a horizontal component.

Fluid flowing through a fluidic module may flow into an inlet (e.g., an inlet present in the first channel), and then into the first channel. The inlet may be configured to receive fluid from a bioreactor and/or from another system component (e.g., another fluidic module, such as a fluidic module comprising two channels separated by a membrane). After entering the first channel, some or all of the fluid may flow through the membrane, the second channel, and then an outlet positioned in the second channel. When the first channel also comprises an outlet, it is also possible for some of the fluid to flow over the membrane and out the outlet positioned in the first channel. Fluid flowing through either outlet may be disposed of or passed to a different portion of the fluidic device for further processing, analysis, and/or recovery of a product therefrom. For instance, fluid flowing out either or both outlets may be provided to an analyzer. As another example, fluid flowing through either or both outlets may be provided to another fluidic module (e.g., also comprising two channels separated by a membrane). As a third example, fluid flowing out of an outlet positioned in the first channel may be recirculated to the first channel's inlet (e.g., for further purification). In other words, the first channel's outlet may be in fluidic communication with the first channel's inlet through a pathway other than the first fluidic channel.

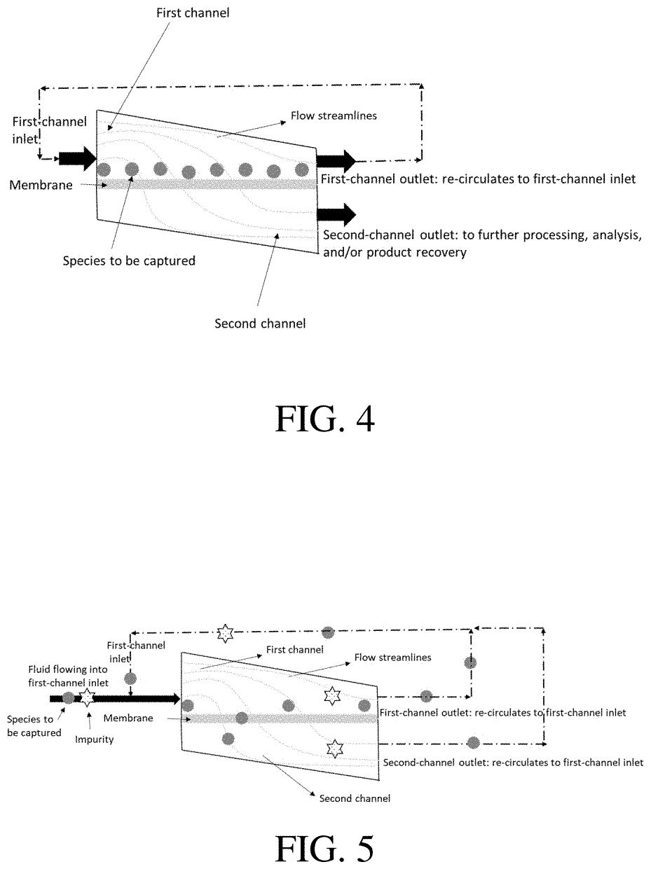

In some embodiments, a fluidic module may be configured and/or operated such that fluid flowing out of the first-channel outlet is recirculated to the first-channel inlet and fluid flowing out of the second-channel outlet is passed to a different portion of the fluidic device for further processing, analysis, and/or recovery of a product. Such flow is shown schematically in FIG. 4.

A variety of suitable types of analyzers may receive fluid from an outlet in a fluidic module. Non-limiting examples of suitable analyzers include metabolite analyzers, analyzers comprising mass spectrometers, analyzers configured to detect electrochemical potentiometric signals, analyzer configured to detect plasmon resonance signals, and/or analyzer configured to detect optical signals. Analyzers configured to detect signals may be configured to detect signals originating from the fluid and/or that may vary depending on one or more properties of the fluid. In some embodiments, an analyzer comprises a plurality of ligands configured to bind to a species present in the fluid. In some such embodiments, the analyzer may detect a signal that originates with the bound species.

In some embodiments, fluid flowing through a second channel's outlet is recirculated to a first channel's inlet. It is also possible for the second-channel outlet to be configured to provide fluid to the first-channel inlet. In such embodiments, the second channel's outlet may be in fluidic communication with the first channel's inlet through a pathway other than the membrane (e.g., tubing connecting the first channel's outlet to its inlet). This may be desirable when there is a species present in the fluid that it is desirable to capture on the membrane (e.g., via binding) but for which some amount of breakthrough (such as flow of the species through the membrane, such as from the first channel into the second channel) is expected and/or detected. In such instances, some of that species flows through the membrane (i.e., passes across the membrane) into the second channel. Flowing such fluid out of the second-channel outlet and into the first-channel inlet allows it to be exposed to the membrane again, and allows some or all of the species that passed through the membrane to be captured on the membrane. Fluid may flow through the fluidic modules herein in a variety of suitable manners. In some embodiments, some or all of the following steps may be performed. Such steps may be performed in the sequence described, or in a different sequence.

As shown in FIG. 5, in some embodiments, a fluid comprising a species to be captured and an impurity are flowed through a fluidic module. The flow may comprise flowing the fluid into a first-channel inlet and into the first channel, flowing a portion of the fluid through the membrane and into the second channel, flowing the portion of the fluid not flowed through the membrane through the first-channel outlet, and flowing the portion of the fluid flowed through the membrane through the second-channel outlet. Some of the species to be captured may be captured by the membrane, and some of the species to be captured may break through (e.g., flow through, instead of being captured by) the membrane. The impurity may be present in both the fluid flowed through the membrane and the fluid not flowed through the membrane. Fluid flowed out of both the first-channel outlet and the second-channel outlet may be recirculated to the first-channel inlet so that species not captured by the membrane may be so captured.

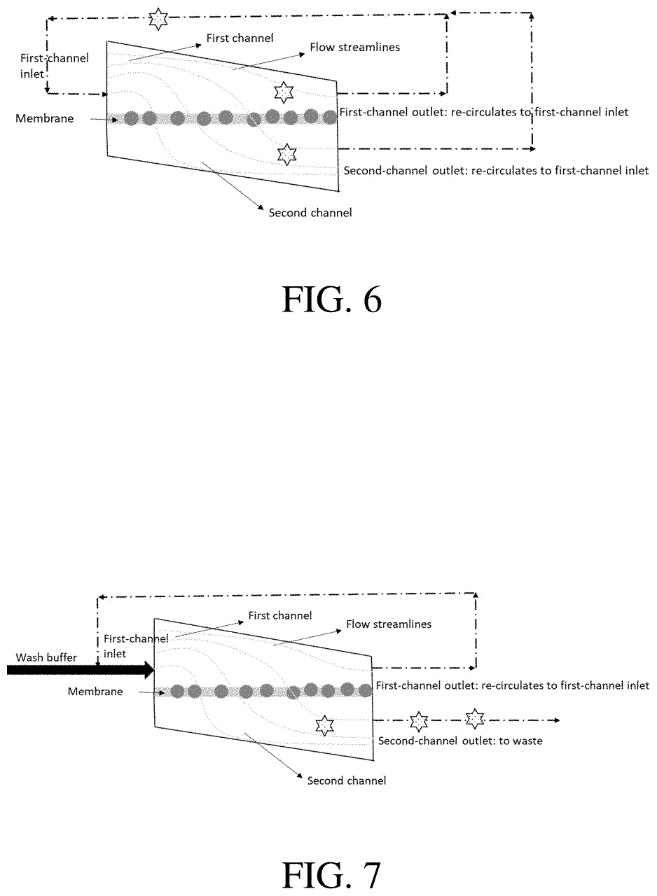

As shown in FIG. 6, in some embodiments, a fluid comprising a species to be captured may be flowed as described above until a relatively high percentage of the species to be captured is captured by the membrane and/or the capacity of the membrane to capture the species is reached. During such flow, fluid flowing out of the first-channel outlet and the second-channel outlet may be flowed into the first-channel inlet. During this process, and during each flow of the fluid through the membrane, at least a portion of the species to be captured may be captured by the membrane when the fluid flows therethrough. After the fluid has flowed through the membrane an appreciable number of times (e.g., at least 2, 3, 4, 5, 6 times, etc.), a relatively high percentage of the species to be captured by the membrane may be so captured and/or the capacity of the membrane to capture the species may be reached. Any impurity present in the fluid may be substantially uncaptured by the membrane and continue to be present in the fluid.

As shown in FIG. 7, in some embodiments, a second, different fluid (e.g., a wash buffer) may be flowed through the fluidic device. This may be performed upon capture of a relatively high percentage of a species to be captured and/or upon reaching the capacity of the membrane to capture the species. During this step, fluid flowing out of the second-channel outlet may be discarded and/or supplied to a waste receptacle. Such fluid may include an appreciable amount of the impurities present in the fluid initially comprising the species to be captured by the membrane. Fluid flowing out of the first-channel outlet may be flowed into the first-channel inlet. Such flow may serve to circulate any impurity remaining in such fluid through the fluidic module, through the membrane, and out of the second-channel outlet.

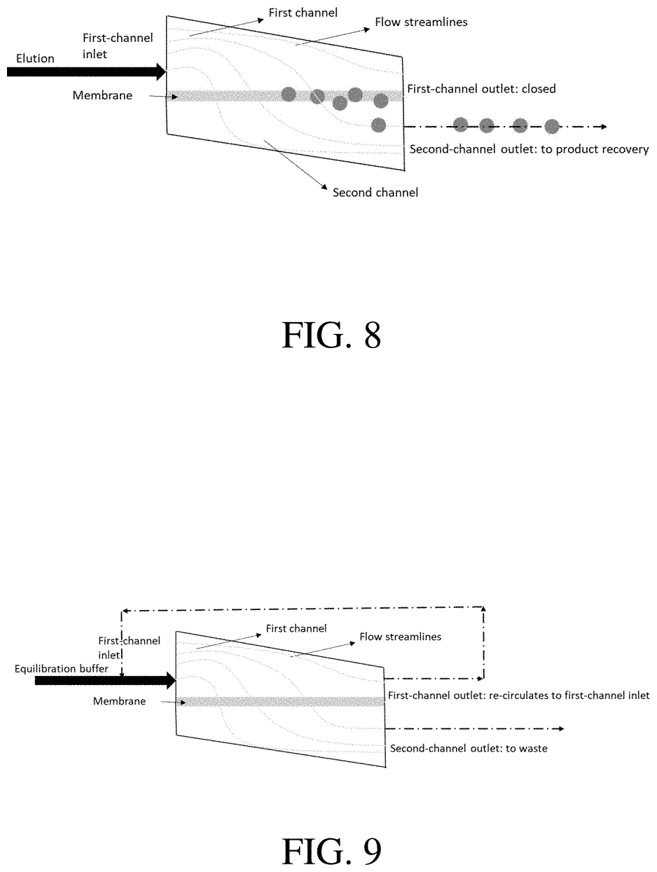

In some embodiments, a fluid (e.g., an elution buffer) may be flowed through the fluidic device that causes species captured on the membrane to elute therefrom. This is shown schematically in FIG. 8. Such a step may be performed after one or more of the steps described above (e.g., after a relatively high percentage of a species to be captured is captured and/or the capacity of the membrane to capture such a species is exhausted, after employing a wash buffer to remove residual impurity). In some embodiments, the process involves closing the first-channel outlet such that during elution of a species from the membrane, the first-channel outlet is closed. The second-channel outlet may be in fluidic communication with a downstream processor, analyzer, and/or location at which the species eluted from the membrane may be recovered.

In some embodiments, subsequent to elution of a species captured on a membrane from the membrane, a fluid (e.g., an equilibration buffer) may be flowed through the fluidic device. During this step, fluid flowing out of the second-channel outlet may be discarded and/or supplied to a waste receptacle. This fluid may include remaining residues of the buffer from a previous step described above (e.g., an elution buffer). Fluid flowing out of the first-channel outlet may flow into the first-channel inlet. Such fluid flow may serve to circulate any remaining residues of the buffer from a previous step described above (e.g., elution buffer) through the fluidic module, through the membrane, and out of the second-channel outlet. This step may establish conditions through the membrane where the species may be captured again to the membrane. This step is shown schematically in FIG. 9. As shown in FIGS. 1-3, in some embodiments, a dimension perpendicular to a membrane (e.g., a height, a depth, a lateral dimension) may vary along the length of the channel. The dimension perpendicular to the membrane may be a dimension that extends perpendicularly from the surface of the membrane and terminates on a wall of the channel that opposes the membrane. For instance, when a channel is disposed on a membrane, the dimension perpendicular to the membrane for that channel may be the height. As another example, when a channel is positioned beneath a membrane, the dimension perpendicular to the membrane may be the depth. As a third example, when a channel is positioned beside a membrane, the dimension perpendicular to the membrane may be a lateral dimension.

For a first channel, a dimension perpendicular to the membrane (e.g., a height, a width, a lateral dimension) may decrease from a first portion thereof proximal to the inlet to a second portion thereof distal to the inlet. For the second channel, a dimension perpendicular to the membrane (e.g., a height, a width, a lateral dimension) may increase from a first portion thereof distal to the outlet to a second portion thereof proximal to the outlet. For instance, with reference to FIG. 2, in some embodiments, a first channel 202 has a height 702 that decreases from a first portion 802 proximal to the inlet 502 to a second portion 852 distal to the inlet 502. As another example, also with reference to FIG. 2, a second channel 302 may have a depth 902 that increases from a first portion 1002 distal to the outlet 602 to a second portion 1052 proximal to the outlet 602. In embodiments in which the first and second channels are side by side, the lateral dimension of the first channel may decrease from a first portion thereof proximal to the inlet to a second portion thereof distal to the inlet and/or the lateral dimension of the second channel may increase from a first portion thereof distal to the outlet to a second portion thereof proximal to the outlet.

In some embodiments, like the embodiments shown in FIG. 2, a change in a dimension of a channel perpendicular to a membrane (e.g., a height, a depth, a lateral dimension) may be substantially monotonic from one end of the channel to the other. It is also possible for a fluidic module to comprise a channel that both comprises one or more portions along which a dimension perpendicular to the membrane decreases and comprises one or more portions along which a dimension perpendicular to the membrane is constant or increases. Like in FIG. 2, the portion of the channel along which the dimension perpendicular to the membrane changes (e.g., substantially monotonically) may extend from a portion proximal to the channel's inlet to a portion distal to the channel's inlet (e.g., for a first channel comprising an inlet) and/or from a portion distal to the channel's inlet to a portion proximal to the channel's outlet (e.g., for a second channel comprising an outlet).

It should also be noted that the rate of the change of a dimension of a channel perpendicular to the membrane (e.g., a height, a depth, a lateral dimension) may vary along the length of the channel (e.g., as shown in FIGS. 1-3) or may be constant along the length of the channel. Additionally, in embodiments in which both the first channel and the second channel comprise a dimension perpendicular to the membrane that varies, the rate of change of the dimension of a first channel may have the same magnitude (but the opposite sign) of the rate of change of the second channel at one, some, or all portions of the first and second channels locations (e.g., across the entirety of the lengths of the first and second channels). In such embodiments, it is also possible for the rates of change of the dimensions of the first and second channels to have different magnitudes at all locations along the first and second channels.

When a channel's dimension perpendicular to the membrane (e.g., a height, a depth, a lateral dimension) changes substantially monotonically, the change in the dimension perpendicular to the membrane may be identically monotonic across a relatively large percentage of the channel portion for which the change is substantially monotonic. For instance, in some embodiments, a channel's dimension perpendicular to the membrane changes identically monotonically across greater than or equal to 90%, greater than or equal to 91%, greater than or equal to 92%, greater than or equal to 93%, greater than or equal to 94%, greater than or equal to 95%, greater than or equal to 96%, greater than or equal to 97%, greater than or equal to 98%, or greater than or equal to 99% of the length of the portion for which the height decreases or depth increases substantially monotonically. In some embodiments, a channel's dimension perpendicular to the membrane changes identically monotonically across less than or equal to 100%, less than or equal to 99%, less than or equal to 98%, less than or equal to 97%, less than or equal to 96%, less than or equal to 95%, less than or equal to 94%, less than or equal to 93%, less than or equal to 92%, or less than or equal to 91% of the length of the portion for which the height decreases or depth increases substantially monotonically. Combinations of the above-referenced ranges are also possible (e.g., greater than or equal to 90% and less than or equal to 100%, or greater than or equal to 95% and less than or equal to 100%). Other ranges are also possible.

In some embodiments, a channel's dimension perpendicular to the membrane (e.g., a height, a depth, a lateral dimension) changes substantially monotonically across a portion of a channel, and the change in the channel's dimension perpendicular to the membrane across that portion of the channel may deviate from identical monotonicity by a relatively small amount. As an example, in some embodiments, an ideal change in a dimension perpendicular to the membrane that is identically monotonic may be fit to the actual change in a dimension perpendicular to the membrane and may have an R² value of greater than or equal to 0.9, greater than or equal to 0.91, greater than or equal to 0.92, greater than or equal to 0.93, greater than or equal to 0.94, greater than or equal to 0.95, greater than or equal to 0.96, greater than or equal to 0.97, greater than or equal to 0.98, or greater than or equal to 0.99. In some embodiments, an ideal change in dimension perpendicular to the membrane that is identically monotonic may be fit to the actual change in a dimension perpendicular to the membrane and may have an R² value of less than or equal to 1, less than or equal to 0.99, less than or equal to 0.98, less than or equal to 0.97, less than or equal to 0.96, less than or equal to 0.95, less than or equal to 0.94, less than or equal to 0.93, less than or equal to 0.92, or less than or equal to 0.91. Combinations of the above-referenced ranges are also possible (e.g., greater than or equal to 0.9 and less than or equal to 1, or greater than or equal to 0.95 and less than or equal to 1). Other ranges are also possible.

When a change in a channel's dimension perpendicular to the membrane (e.g., a height, a depth, a lateral dimension) is substantially monotonic across a portion, but not all, of the channel, the portion of the channel over which the change in which the channel's dimension perpendicular to the membrane is substantially monotonic may occupy a relatively large percentage of the channel. For instance, in some embodiments, the portion of the channel over which the channel's dimension perpendicular to the membrane changes substantially monotonically extends from a portion proximal to the channel's inlet, and the distance from the portion proximal to the channel's inlet to the channel's inlet is less than or equal to 10%, less than or equal to 9%, less than or equal to 8%, less than or equal to 7%, less than or equal to 6%, less than or equal to 5%, less than or equal to 4%, less than or equal to 3%, less than or equal to 2%, or less than or equal to 1% of the length of the channel. In some embodiments, the portion of the channel over which the channel's dimension perpendicular to the membrane changes substantially monotonically extends from a portion proximal to the channel's inlet, and the distance from the portion proximal to the channel's inlet to the channel's inlet is greater than or equal to 0%, greater than or equal to 1%, greater than or equal to 2%, greater than or equal to 3%, greater than or equal to 4%, greater than or equal to 5%, greater than or equal to 6%, greater than or equal to 7%, greater than or equal to 8%, or greater than or equal to 9% of the length of the channel. Combinations of the above-referenced ranges are also possible (e.g., less than or equal to 10% and greater than or equal to 0%, or less than or equal to 5% and greater than or equal to 0%). Other ranges are also possible.

In some embodiments, a portion of the channel over which the channel's dimension perpendicular to the membrane (e.g., a height, a depth, a lateral dimension) changes substantially monotonically extends to a portion distal to the channel's inlet, and the distance from the portion distal to the channel's inlet to the channel's inlet is greater than or equal to 90%, greater than or equal to 91%, greater than or equal to 92%, greater than or equal to 93%, greater than or equal to 94%, greater than or equal to 95%, greater than or equal to 96%, greater than or equal to 97%, greater than or equal to 98%, or greater than or equal to 99% of the length of the channel. In some embodiments, a portion of the channel over which the channel's dimension perpendicular to the membrane changes substantially monotonically extends to a portion distal to the channel's inlet, and the distance from the portion distal to the channel's inlet to the channel's inlet is less than or equal to 100%, less than or equal to 99%, less than or equal to 98%, less than or equal to 97%, less than or equal to 96%, less than or equal to 95%, less than or equal to 94%, less than or equal to 93%, less than or equal to 92%, or less than or equal to 91% of the length of the channel. Combinations of the above-referenced ranges are also possible (e.g., greater than or equal to 90% and less than or equal to 100%, or greater than or equal to 95% and less than or equal to 100%). Other ranges are also possible.

In some embodiments, the portion of a channel over which the channel's dimension perpendicular to the membrane (e.g., a height, a depth, a lateral dimension) changes substantially monotonically extends from a portion proximal to the channel's outlet, and the distance from the portion proximal to the channel's outlet to the channel's outlet is less than or equal to 10%, less than or equal to 9%, less than or equal to 8%, less than or equal to 7%, less than or equal to 6%, less than or equal to 5%, less than or equal to 4%, less than or equal to 3%, less than or equal to 2%, or less than or equal to 1% of the length of the channel. In some embodiments, the portion of the channel over which the channel's dimension perpendicular to the membrane changes substantially monotonically extends from a portion proximal to the channel's outlet, and the distance from the portion proximal to the channel's outlet to the channel's outlet is greater than or equal to 0%, greater than or equal to 1%, greater than or equal to 2%, greater than or equal to 3%, greater than or equal to 4%, greater than or equal to 5%, greater than or equal to 6%, greater than or equal to 7%, greater than or equal to 8%, or greater than or equal to 9% of the length of the channel. Combinations of the above-referenced ranges are also possible (e.g., less than or equal to 10% and greater than or equal to 0%, less than or equal to 5% and greater than or equal to 0%). Other ranges are also possible.

In some embodiments, a portion of the channel over which the channel's dimension perpendicular to the membrane (e.g., a height, a depth, a lateral dimension) changes substantially monotonically extends to a portion distal to the channel's outlet, and the distance from the portion distal to the channel's outlet to the channel's outlet is greater than or equal to 90%, greater than or equal to 91%, greater than or equal to 92%, greater than or equal to 93%, greater than or equal to 94%, greater than or equal to 95%, greater than or equal to 96%, greater than or equal to 97%, greater than or equal to 98%, or greater than or equal to 99% of the length of the channel. In some embodiments, a portion of the channel over which the channel's dimension perpendicular to the membrane changes substantially monotonically extends to a portion distal to the channel's outlet, and the distance from the portion distal to the channel's inlet to the channel's inlet is less than or equal to 100%, less than or equal to 99%, less than or equal to 98%, less than or equal to 97%, less than or equal to 96%, less than or equal to 95%, less than or equal to 94%, less than or equal to 93%, less than or equal to 92%, or less than or equal to 91% of the length of the channel. Combinations of the above-referenced ranges are also possible (e.g., greater than or equal to 90% and less than or equal to 100%, greater than or equal to 95% and less than or equal to 100%). Other ranges are also possible.

Some methods described herein may comprise flowing a fluid through a fluidic module described herein. For instance, in some embodiments, a method comprises flowing a fluid through a first fluidic channel, through a membrane positioned adjacent the first fluidic channel, and into a second fluidic channel positioned on the other side of (e.g., across from) the membrane. The fluid may flow into the first fluidic channel through an inlet and/or out of the second fluidic channel through an outlet. Additionally, in some embodiments, at least a portion of the fluid may flow out of an outlet positioned in the first fluidic channel. Some fluidic modules may have a design such that fluid flowing from the first channel, through the membrane, and into the second fluidic channel experiences a pressure drop that is relatively independent of the location at which the fluid flows through the membrane. In other words, as described above, the pressure drop may be substantially constant over the membrane area. This may advantageously facilitate a flow through the membrane that varies relatively little over the membrane area.

In some embodiments, a fluidic module is configured such that fluid flowing through the fluidic module (e.g., from a first channel to a second channel, from an inlet positioned in the first channel to an outlet positioned in the second channel) experiences a pressure drop through a membrane therein that is substantially constant over the membrane area, and a standard deviation of the pressure drop over the membrane area is less than or equal to 15%, less than or equal to 12.5%, less than or equal to 10%, less than or equal to 9%, less than or equal to 8%, less than or equal to 7%, less than or equal to 6%, less than or equal to 5%, less than or equal to 4%, less than or equal to 3%, less than or equal to 2%, or less than or equal to 1% of the average pressure drop over the membrane area. In some embodiments, a standard deviation of the pressure drop over the membrane area is greater than or equal to 0%, greater than or equal to 1%, greater than or equal to 2%, greater than or equal to 3%, greater than or equal to 4%, greater than or equal to 5%, greater than or equal to 6%, greater than or equal to 7%, greater than or equal to 8%, greater than or equal to 9%, greater than or equal to 10%, or greater than or equal to 12.5% of the average pressure drop over the membrane area. Combinations of the above-referenced ranges are also possible (e.g., less than or equal to 15% and greater than or equal to 0%, less than or equal to 10% and greater than or equal to 0%, or less than or equal to 5% and greater than or equal to 0%). Other ranges are also possible.

In some embodiments, a fluidic module is configured such that the flow rate through a membrane positioned between two channels therein is substantially constant over the membrane area. For instance, the standard deviation of the flow rate through the membrane over the membrane area may be less than or equal to 15%, less than or equal to 12.5%, less than or equal to 10%, less than or equal to 9%, less than or equal to 8%, less than or equal to 7%, less than or equal to 6%, less than or equal to 5%, less than or equal to 4%, less than or equal to 3%, less than or equal to 2%, or less than or equal to 1% of the average fluid flow through the membrane. In some embodiments, the standard deviation of the flow rate through the membrane over the membrane area is greater than or equal to 0%, greater than or equal to 1%, greater than or equal to 2%, greater than or equal to 3%, greater than or equal to 4%, greater than or equal to 5%, greater than or equal to 6%, greater than or equal to 7%, greater than or equal to 8%, greater than or equal to 9%, greater than or equal to 10%, or greater than or equal to 12.5% of the average fluid flow through the membrane. Combinations of the above-referenced ranges are also possible (e.g., greater than or equal to 0% and less than or equal to 15%, greater than or equal to 0% and less than or equal to 10%, or greater than or equal to 0% and less than or equal to 5%). Other ranges are also possible.

The anticipated pressure drop for fluid flowing through various portions of a membrane and the anticipated flow rate through various portions of a membrane may be determined by solving fluid dynamics equations. For a fluidic module comprising a single inlet and a single outlet, the fluid flow rate through the inlet is equal to the fluid flow through the outlet and can be denoted by the variable Q. A membrane spanning a side (e.g., a base, a top, a side wall) of the channel may be divided into portions that each span a dimension (e.g., a width) of the channel perpendicular to fluid flow and increase in index number from the upstream portion of the fluidic module to the downstream portion of the fluidic module. Then, the flow rate through any portion of the membrane may be denoted by the variable Qₘᵢ. In the case of a constant flow rate through the membrane across the membrane area, Qₘᵢ may be equivalent to Q/n, where n is the total number of portions in the membrane. With this in mind, the flow rate through a portion of the channel comprising an inlet may be denoted by the variable Q₁ᵢ and may be determined by solving the following equation:

$${Q}_{1 i} = Q - i * \frac{Q}{n} .$$

Similarly, the flow rate through a portion of the channel receiving fluid from the channel comprising the inlet may be denoted by the variable Q₂ᵢ and may be determined by solving the following equation:

$${Q}_{2 i} = i * \frac{Q}{n} .$$

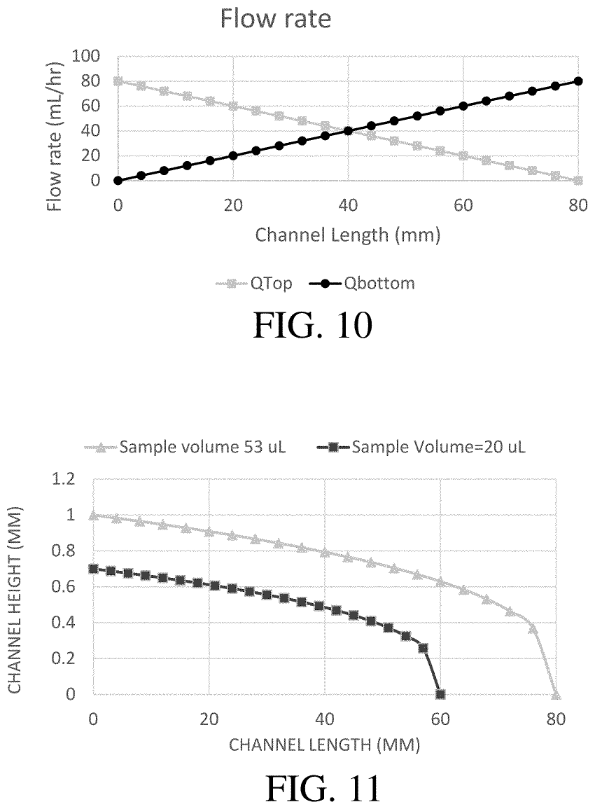

FIG. 10 shows a plot of the flow rate in a top channel and a bottom channel in a fluidic module in which an inlet is positioned in the top channel and an outlet is positioned in the bottom channel and for which the flow through the membrane is constant across the membrane area. Similar data would be expected for modules comprising other arrangements of channels and membranes as described elsewhere herein. As shown in FIG. 10, the flow in the top channel decreases along the length of the channel and the flow in the bottom channel increases along the length of the channel.

The pressure drop through a portion of a membrane may be denoted by the variable ΔPₘᵢ. ΔPₘᵢ may be determined by solving the following equation: A Pₘᵢ=Rₘ*Qₘᵢ, where Rₘ is the resistance of the membrane. For fluidic modules having the characteristics described in the preceding paragraph and for which the channel dimension perpendicular to fluid flow in the plane of the membrane (e.g., width) is constant, the pressure drop through a channel comprising an inlet and having a rectangular cross-section may be determined by solving the following equation:

$$Δ {P}_{ti} = {P}_{1 i + 1} - {P}_{1 i} = \frac{12 μΔ L}{{W}_{1} {h}_{1 i}^{3} ( 1 - 0.63 \frac{{h}_{1 i}}{{W}_{1}} )} {Q}_{1 i} ,$$

where P₁ᵢ₊₁ is the pressure in the portion of the channel directly downstream of the portion of the channel for which the pressure drop is being computed, P₁ᵢ is the pressure in the portion of the channel for which the pressure drop is being computed, μ is the viscosity of the fluid flowing through the fluidic module, ΔL is the length of the portion of the channel for which the pressure drop is being computed, W₁ is the dimension of the channel perpendicular to fluid flow in the plane of the membrane (e.g., width), and h₁ᵢ is the dimension of the channel perpendicular to the membrane (e.g., height, depth, lateral dimension). The dimensions of the channel perpendicular to the membrane (e.g., heights, depths, lateral dimensions) at each portion of the channel that result in a constant pressure drop that is minimized may be determined from this equation. FIG. 11 shows a plot for two possible height profiles of a channel comprising an inlet and positioned above a channel comprising an outlet for two different sample volumes. Similar data would be expected for modules comprising other arrangements of channels and membranes (e.g., in which the channel comprising the inlet is positioned beneath a channel comprising an outlet, in which the channel comprising the inlet is positioned beside a channel comprising an outlet) as described elsewhere herein.

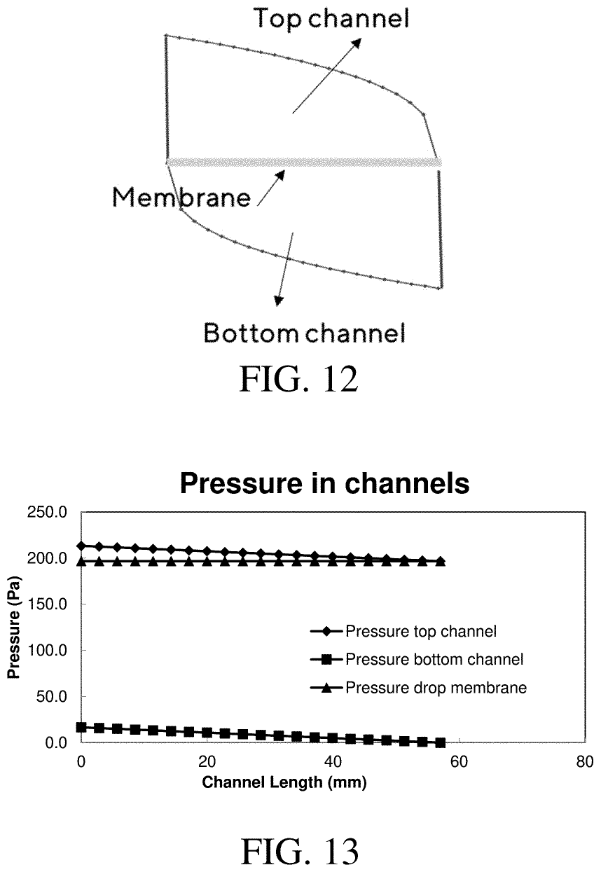

In some embodiments, a fluidic module comprises channels separated by a membrane and having rectangular cross-sections for which the dimensions of the channels perpendicular to fluid flow in the plane of the membrane (e.g., widths) are equal. In such embodiments, the profile of the dimension of the channel perpendicular to the membrane (e.g., height, depth, lateral dimension) for the channel receiving the flow may be the opposite of the profile of the dimension of the channel perpendicular to the membrane (e.g., height, width, lateral dimension) for the channel providing the flow. This is shown schematically in FIG. 12 for the embodiment in which the channel providing the fluid flow is positioned above the channel receiving the fluid flow. In such cases, the height profile of the channel receiving the fluid flow may be the opposite of the depth profile of the channel providing the fluid flow. Similar data would be expected for modules comprising other arrangements of channels and membranes (e.g., in which the channel comprising the inlet is positioned beneath a channel comprising an outlet, in which the channel comprising the inlet is positioned beside a channel comprising an outlet) as described elsewhere herein.

In embodiments in which a fluidic module comprises a channel with a varying dimension of the channel perpendicular to fluid flow in the plane of the membrane (e.g., width), the equations provided above can be modified such that h₁ differs for different portions of the channel. In such embodiments, the pressure in each portion of the channel receiving the fluid flow may be denoted by the variable P₂ᵢ. P₂ᵢ may be determined by solving the following equation: P₂ᵢ=P₁ᵢ+ΔPₘᵢ. Additionally, it may be assumed that the pressure at the outlet of the channel receiving the fluid is equivalent to the atmospheric pressure (Pₐₜₘ). Then, the pressure drop through a channel comprising an outlet and having a rectangular cross-section may be determined by solving the following equation:

$$Δ {P}_{2 i} = {P}_{2 i + 1} - {P}_{2 i} = \frac{12 μΔ L}{{W}_{2} {d}_{2 i}^{3} ( 1 - 0.63 \frac{{d}_{2}}{{W}_{2}} )} {Q}_{2 i} ,$$

where P₂ᵢ₊₁ is the pressure in the portion of the channel directly downstream of the portion of the channel for which the pressure drop is being computed, P₂ᵢ is the pressure in the portion of the channel for which the pressure drop is being computed, μ is the viscosity of the fluid flowing through the fluidic module, ΔL is the length of the portion of the channel for which the pressure drop is being computed, W₂ is the channel's dimension of the channel perpendicular to the membrane (e.g., width), d₂ᵢ is the channel's dimension perpendicular to the membrane (e.g., height, depth, lateral dimension), and Q₂ᵢ is the flow through the portion of the channel. FIG. 13 schematically shows the pressures present in two channels and a membrane present in a fluidic module. For the data shown in FIG. 13, the channel comprising the inlet is the top channel and the channel comprising the outlet is the bottom channel. As can be seen from FIG. 13, the pressure drop for fluid flowing through the membrane is substantially constant across the membrane. Similar data would be expected for modules comprising other arrangements of channels and membranes (e.g., in which the channel comprising the inlet is positioned beneath a channel comprising an outlet, in which the channel comprising the inlet is positioned beside a channel comprising an outlet) as described elsewhere herein.

As described above, in some embodiments, a fluidic module comprises a channel comprising an inlet but not an outlet in combination with a channel comprising an outlet. It is also possible for a fluidic module to comprise one channel comprising both an inlet and an outlet and another channel comprising an outlet. The presence or absence of an outlet may affect the pressure drop of fluid flowing through the membrane. Additionally, the resistance of the membrane may affect the relative amounts of fluid flowing through two channels separated by a membrane and/or the amount of fluid flowing through the membrane. In some embodiments, given a known membrane resistance, the profile of a dimension of the channel perpendicular to the membrane (e.g., height, depth, lateral dimension) for a channel comprising an inlet and an outlet may be selected to cause a desired amount of fluid to flow out of the outlet of the first channel and/or to not flow through the membrane. This amount may be zero (e.g., when the first channel lacks an outlet) or may be a small or appreciable portion of the fluid flowing into the first channel.

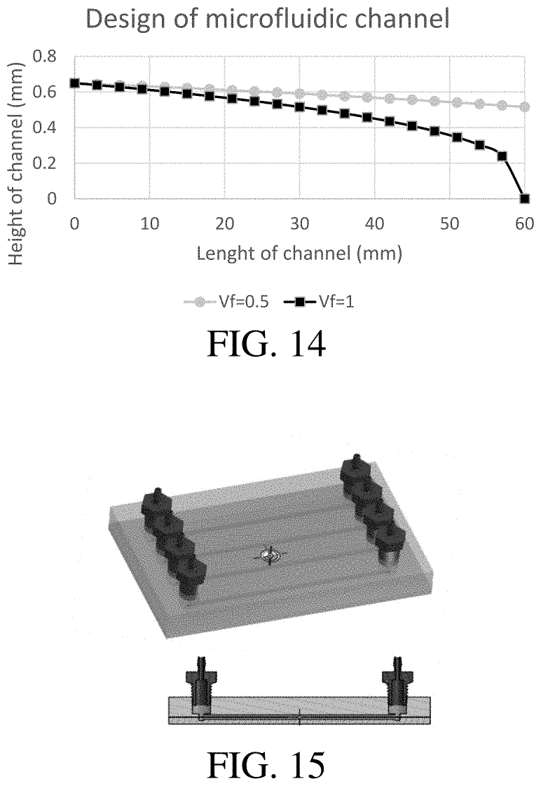

FIG. 14 depicts two exemplary height profiles for a channel comprising an inlet that is positioned above a channel comprising an outlet: one in which the fluidic module is configured such that 100% of the fluid flowing into the first fluidic channel passes through the membrane (this channel lacks an outlet and is shown as trace Vf=1) and flows into the second fluidic channel, and one in which the fluidic module is configured such that 50% of the fluid flowing into the first fluidic channel passes through the membrane and flows into the second fluidic channel and 50% of the fluid flowing into the first fluidic channel flows through the first fluidic channel and out the outlet positioned in the first fluidic channel (this channel comprises an outlet and is shown as trace Vf=0). Similar data would be expected for modules comprising other arrangements of channels and membranes (e.g., in which the channel comprising the inlet is positioned beneath a channel comprising an outlet, in which the channel comprising the inlet is positioned beside a channel comprising an outlet) as described elsewhere herein.

When both first and second channels in a fluidic module comprise outlets, the amount of fluid flowing out the outlet of the second channel (i.e., the channel lacking an inlet) may be selected as desired. In some embodiments, greater than or equal to 5%, greater than or equal to 7.5%, greater than or equal to 10%, greater than or equal to 15%, greater than or equal to 20%, greater than or equal to 30%, greater than or equal to 40%, greater than or equal to 50%, greater than or equal to 60%, or greater than or equal to 80% of the fluid entering the first channel inlet flows out the second channel outlet. In some embodiments, less than or equal to 100%, less than or equal to 80%, less than or equal to 60%, less than or equal to 50%, less than or equal to 40%, less than or equal to 30%, less than or equal to 20%, less than or equal to 15%, less than or equal to 10%, or less than or equal to 7.5% of the fluid entering the first channel inlet flows out the second channel outlet. Combinations of the above-referenced ranges are also possible (e.g., greater than or equal to 5% and less than or equal to 100%). Other ranges are also possible.

Fluid may flow through the fluidic modules described herein in a variety of suitable manners. Flow through the fluidic modules described herein and/or some or all of the components thereof may be laminar. The flow may be continuous or may include portions during which fluid is flowing and portions during which fluid is not flowing. Additionally, the fluid flowing may have a relatively constant composition over time or the composition of the fluid being introduced into the fluidic module may change with time. As further examples, the fluidic modules described herein may be operated in bind/elute mode and/or in flow-through mode.

As described elsewhere herein, in some embodiments, multiple fluidic modules may be placed in a single fluidic device. Some embodiments relate to such fluidic devices. The fluidic device may comprise two or more fluidic modules, all, some, or none of which may be identical to each other. In other words, a fluidic device may comprise two or more identical fluidic modules and/or may comprise two or more fluidic modules that differ in one or more ways. One example of a possible difference between fluidic modules is the membrane type. When a fluidic device comprises two or more modules, some of the modules may be arranged serially (e.g., fluid exiting an outlet of one fluidic module may then flow into the inlet of another fluidic modules) and/or some of the modules may be arranged in parallel (e.g., a fluid may be split and flow into two or more different fluidic modules, fluid recovered from two or more fluidic modules may be combined into a single fluid stream). FIG. 15 shows a schematic depiction of one non-limiting example of a fluidic device comprising three parallel fluidic modules.

One non-limiting examples of a suitable serial arrangements of fluidic modules is the following (in order from upstream to downstream): (1) a fluidic module comprising a membrane configured for cell clarification; (2) a fluidic module comprising a membrane configured for protein A purification; (3) a fluidic module comprising an ion exchange membrane; and (4) a fluidic module comprising a membrane configured for virus removal.

The fluidic devices described herein may be suitable for use in a variety of applications. Such applications may include bioprocessing, water treatment, chemical processing and/or synthesis, polymer processing and/or synthesis, and/or drug development. In some embodiments, the fluidic devices described herein may be employed to screen processing parameters (e.g., membrane area, flow rate, elution volume, etc.) for further scale-up.

As described elsewhere herein, the fluidic modules described herein may comprise channels. The fluidic modules and channels may have a variety of suitable volumes. In some embodiments, the entire fluidic module, a channel of a fluidic module, and/or all of the channels of the module have a volume (e.g., a volume suitable for fluid flow) of greater than or equal to 1 microliter, greater than or equal to 2 microliters, greater than or equal to 5 microliters, greater than or equal to 7.5 microliters, greater than or equal to 10 microliters, greater than or equal to 20 microliters, greater than or equal to 50 microliters, greater than or equal to 75 microliters, greater than or equal to 100 microliters, greater than or equal to 150 microliters, greater than or equal to 200 microliters, greater than or equal to 250 microliters, greater than or equal to 350 microliters, greater than or equal to 400 microliters, or greater than or equal to 450 microliters. In some embodiments, the channel has a volume of less than or equal to 500 microliters, less than or equal to 450 microliters, less than or equal to 400 microliters, less than or equal to 350 microliters, less than or equal to 250 microliters, less than or equal to 200 microliters, less than or equal to 150 microliters, less than or equal to 100 microliters, less than or equal to 75 microliters, less than or equal to 50 microliters, less than or equal to 20 microliters, less than or equal to 10 microliters, less than or equal to 7.5 microliters, less than or equal to 5 microliters, or less than or equal to 2 microliters. Combinations of the above-referenced ranges are also possible (e.g., greater than or equal to 1 microliter and less than or equal to 500 microliters). Other ranges are also possible.

When a fluidic module comprises two or more channels, each channel may independently have a volume in one or more of the ranges described above.

The channels described herein may have a variety of suitable lengths. In some embodiments, one or more, or each channel in a fluidic module independently has a length of one or more of the following ranges: greater than or equal to 0.01 mm, greater than or equal to 0.02 mm, greater than or equal to 0.05 mm, greater than or equal to 0.075 mm, greater than or equal to 0.1 mm, greater than or equal to 0.2 mm, greater than or equal to 0.5 mm, greater than or equal to 0.75 mm, greater than or equal to 1 mm, greater than or equal to 2 mm, greater than or equal to 5 mm, greater than or equal to 7.5 mm, greater than or equal to 10 mm, greater than or equal to 20 mm, greater than or equal to 50 mm, greater than or equal to 75 mm, greater than or equal to 100 mm, or greater than or equal to 150 mm. In some embodiments, each channel in a fluidic module independently has a length of less than or equal to 200 mm, less than or equal to 150 mm, less than or equal to 100 mm, less than or equal to 75 mm, less than or equal to 50 mm, less than or equal to 20 mm, less than or equal to 10 mm, less than or equal to 7.5 mm, less than or equal to 5 mm, less than or equal to 2 mm, less than or equal to 1 mm, less than or equal to 0.75 mm, less than or equal to 0.5 mm, less than or equal to 0.2 mm, less than or equal to 0.1 mm, less than or equal to 0.075 mm, less than or equal to 0.05 mm, or less than or equal to 0.02 mm. Combinations of the above-referenced ranges are also possible (e.g., greater than or equal to 0.01 mm and less than or equal to 200 mm, or greater than or equal to 1 mm and less than or equal to 200 mm). Other ranges are also possible.

The channels described herein may have a variety of suitable dimensions in the plane of the membrane and perpendicular to fluid flow. Such dimensions may be referred to elsewhere herein as “widths” even if they are oriented vertically. In some embodiments, one or more, or each channel in a fluidic module independently has a width of one or more of the following ranges: greater than or equal to 0.01 mm, greater than or equal to 0.02 mm, greater than or equal to 0.05 mm, greater than or equal to 0.075 mm, greater than or equal to 0.1 mm, greater than or equal to 0.2 mm, greater than or equal to 0.5 mm, greater than or equal to 0.75 mm, greater than or equal to 1 mm, greater than or equal to 2 mm, greater than or equal to 5 mm, or greater than or equal to 7.5 mm. In some embodiments, each channel in a fluidic module independently has a width of less than or equal to 10 mm, less than or equal to 7.5 mm, less than or equal to 5 mm, less than or equal to 2 mm, less than or equal to 1 mm, less than or equal to 0.75 mm, less than or equal to 0.5 mm, less than or equal to 0.2 mm, less than or equal to 0.1 mm, less than or equal to 0.075 mm, less than or equal to 0.05 mm, or less than or equal to 0.02 mm. Combinations of the above-referenced ranges are also possible (e.g., greater than or equal to 0.01 mm and less than or equal to 10 mm, or greater than or equal to 0.1 mm and less than or equal to 10 mm). Other ranges are also possible.

For channels for which the width varies along the length of the channel, the channel may have a maximum width in one or more of the ranges described above, a minimum width in one or more of the ranges described above, an average width in one or more of the ranges described above, and/or a modal width in one or more of the ranges described above.

The fluidic devices described herein may be configured to process fluids having a variety of suitable volumes and the methods described herein may relate to flowing fluids having a variety of suitable volumes through fluidic modules. In some embodiments, the fluid has a volume of greater than or equal to 0.1 microliter, greater than or equal to 0.2 microliters, greater than or equal to 0.5 microliters, greater than or equal to 0.75 microliters, greater than or equal to 1 microliter, greater than or equal to 2 microliters, greater than or equal to 5 microliters, greater than or equal to 7.5 microliters, greater than or equal to 10 microliters, greater than or equal to 20 microliters, greater than or equal to 50 microliters, greater than or equal to 75 microliters, greater than or equal to 100 microliters, greater than or equal to 150 microliters, greater than or equal to 200 microliters, greater than or equal to 250 microliters, greater than or equal to 350 microliters, greater than or equal to 400 microliters, or greater than or equal to 450 microliters. In some embodiments, the fluid has a volume of less than or equal to 500 microliters, less than or equal to 450 microliters, less than or equal to 400 microliters, less than or equal to 350 microliters, less than or equal to 250 microliters, less than or equal to 200 microliters, less than or equal to 150 microliters, less than or equal to 100 microliters, less than or equal to 75 microliters, less than or equal to 50 microliters, less than or equal to 20 microliters, less than or equal to 10 microliters, less than or equal to 7.5 microliters, less than or equal to 5 microliters, less than or equal to 2 microliters, less than or equal to 1 microliter, less than or equal to 0.75 microliters, less than or equal to 0.5 microliters, or less than or equal to 0.2 microliters. Combinations of the above-referenced ranges are also possible (e.g., greater than or equal to 0.1 microliter and less than or equal to 500 microliters, or greater than or equal to 1 microliter and less than or equal to 500 microliters). Other ranges are also possible.

A variety of suitable membranes may be employed in the fluidic modules described herein. For instance, membranes suitable for and/or configured for cell clarification, virus removal, affinity chromatography, protein A purification, ion exchange chromatography (e.g., anion exchange chromatography), exosome purification, hydrophobic interaction chromatography, diafiltration, ultrafiltration, and/or monoclonal antibody polishing may be employed. Further examples of suitable membranes include track-etch membranes and non-woven membranes. In some embodiments, a fluidic module comprises a membrane that is configured to remove one or more components from a fluid flowing therethrough by binding a species present therein. The membrane may later elute this species (e.g., into a second, different fluid). It is also possible for a fluidic membrane to be configured to remove one or more components from a fluid flowing therethrough by sieving (e.g., the membrane may be impermeable to one or more species in a fluid flowing therethrough).

In some embodiments, a fluidic module comprises a membrane that fouls in a relatively uniform manner and/or a method comprises fouling a membrane in a relatively uniform manner. The membrane may be configured such that a species bound to and/or deposited on the membrane is dispersed relatively evenly across the membrane. For instance, in some embodiments, an area density of a species bound to and/or deposited on a membrane is substantially constant across the membrane. The standard deviation of the areal density of a species bound to and/or deposited on a membrane may be less than or equal to 10%, less than or equal to 9%, less than or equal to 8%, less than or equal to 7%, less than or equal to 6%, less than or equal to 5%, less than or equal to 4%, less than or equal to 3%, less than or equal to 2%, or less than or equal to 1% of the average areal density of the species bound to and/or deposited on the membrane. The standard deviation of the areal density of a species bound to and/or deposited on a membrane may be greater than or equal to 0%, greater than or equal to 1%, greater than or equal to 2%, greater than or equal to 3%, greater than or equal to 4%, greater than or equal to 5%, greater than or equal to 6%, greater than or equal to 7%, greater than or equal to 8%, or greater than or equal to 9% of the average areal density of the species bound to and/or deposited on the membrane. Combinations of the above-referenced ranges are also possible (e.g., less than or equal to 10% and greater than or equal to 0%). Other ranges are also possible.

When two or more species are bound to and/or deposited on a membrane, the standard deviation of the areal density of each species may independently be in one or more of the ranges described above. In some embodiments, the standard deviation of the areal density of the total amount of all species bound to and/or deposited on a membrane is within one or more of the ranges described above.

Fluidic modules may be fabricated in a variety of suitable manners. In some embodiments, channels in a fluidic module are formed by removing portions of a plastic block (e.g., a poly(propylene) block, an acrylic block, a poly(carbonate) block, a silicone block). This may be accomplished by, for instance, lithography, hot embossing, injection molding, and/or CNC milling. Formation of channels may be followed by fluidic module assembly. This may comprise positioning a membrane between two plastic parts in which channels have been fabricated and then bonding these components together. The bonding may comprise thermal bonding, ultrasound welding, fusion bonding, and/or bonding arising from an adhesive positioned between the components. It is also possible for the bonding to be assisted by the use of a plasma (e.g., an oxygen plasma).

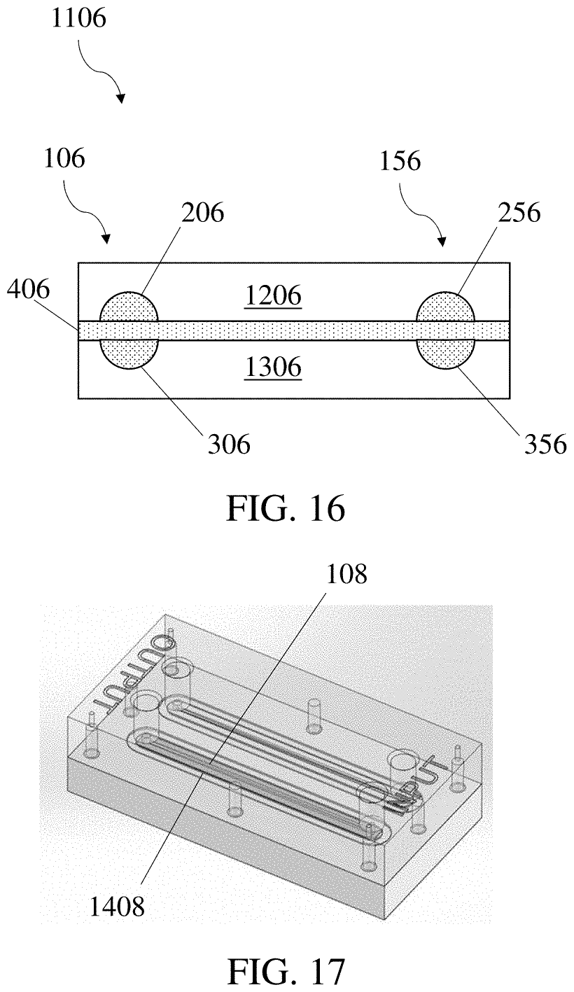

In some embodiments, a fluidic device comprises two or more fluidic modules that share a common membrane. As an example, a fluidic device may comprise two plastic blocks, each plastic block may comprise a channel for each of two or more fluidic modules, and a single membrane may be positioned between the two plastic blocks in a manner that spans two or more channels fluidic modules. A fluidic device having this arrangement is shown in FIG. 16. In FIG. 16, the fluidic device 1106 comprises a first plastic block 1206 and a second plastic block 1306. The channels 206 and 306 are positioned in the first plastic block 1206 and second plastic block 1306, respectively, and together make up a first module 106. Additionally, the channels 256 and 356 are also positioned in the first plastic block 1206 and second plastic block 1306, respectively. These channels together make up a second module 156. A common membrane 406 is shared by both fluidic modules 106 and 156.

It should be noted that, although FIG. 16 shows a single membrane spanning all fluidic modules positioned between two plastic blocks and also spanning the entirety of the interface between the two plastic blocks, other arrangements are also possible. As one example, a fluidic device may comprise two or more membranes positioned between two plastic blocks, at least one of which is shared by two or more fluidic modules. The other membrane may be positioned in one or more fluidic modules. As another example, a fluidic device may comprise a single membrane separating two plastic blocks, but the membrane may only span a portion of the fluidic device and/or may not span the entirety of the interface between the two plastic blocks. It is also possible for a fluidic device to comprise one or membranes that have a width that is similar to (e.g., slightly larger than) those of the channels that it separates. In some embodiments, a fluidic device comprises a plurality of fluidic modules that each comprise a different membrane.

Membranes may be secured to fluidic devices, fluidic modules, and/or plastic blocks in a variety of suitable manners. In some embodiments, a membrane is secured to one or more of the above components by double-sided tape. It is also possible for a membrane to be secured to one or more of the above components by thermal bonding. These techniques may work particularly well for membranes spanning a single fluidic module and/or lacking a porous network that fluidically connects two or more fluidic modules across the membrane (e.g., track-etch membranes, other membranes including pores that are fluidically isolated from each other).

In some embodiments, a membrane is secured to one or more of the above components in a manner that also reduces or eliminates a fluidic pathway through the membrane between two modules that the membrane spans. It is also possible for a membrane to be secured to one or more of the above components by use of double-sided tape and for the membrane to be further treated to reduce or eliminate a fluidic pathway through the membrane between two modules that the membrane spans. Non-limiting examples of manners in which such fluidic pathways may be reduced or eliminated include heat sealing, thermal welding, ultrasonic welding, hot embossing, mechanical sealing, the application of a solvent, an adhesive and/or a silicone that seals some or all of the pores of the membrane with which it is in contact.

Heat sealing, thermal welding, and hot embossing may comprise heating the membrane and/or applying pressure to the membrane. The heat and/or pressure may cause the membrane to deform (e.g., by melting) in a manner that causes pores in the membrane to close. In some embodiments, pressure may be applied by use of a tranche.

Ultrasonic welding may comprise applying pressure to a membrane via vibrations.

Mechanical sealing may comprise the inclusion of a component that compresses the membrane and thereby seals its pores. Non-limiting examples of suitable such components include O-rings and elastomers.

A solvent may be applied to cause the pores to seal. For instance, the solvent may swell, solvate, and/or dissolve the portions of the membrane that it contacts. This may cause the pores in those portions of the membrane to collapse.

Adhesive may be applied to fill pores directly. For instance, adhesive may be dispensed with a needle in one or more desired locations. The dispensing may be performed manually and/or with the assistance of an instrument (e.g., by use of a 3D-printer). The adhesive may wick through the membrane and seal pores at locations in which it is initially positioned and/or at positions to which it wicks. In some embodiments, a polymeric adhesive is employed (e.g., an organic polymer, a 3D-printing resin, superglue, hot glue). The polymer may be initially disposed in a solvent, which may be evaporated to form a solid polymer that seals the pores. In some embodiments, a curable adhesive is employed. The curable adhesive may initially comprise a polymer and/or an oligomer. The application of a stimulus to the curable adhesive may cause a chemical reaction that causes the polymer and/or oligomer to undergo a cross-linking reaction to yield a cross-linked polymer that seals the pores. Non-limiting examples of suitable stimuli include UV light, humidity, and heat.

Silicones (e.g., RTV) may also be applied to fill pores directly. In some embodiments, pressure may be applied concurrently with and/or subsequent to application of a silicone to a membrane. The pressure may assist with transporting the silicone to through the membrane. The silicone may also be bonded to the plastic blocks and/or membrane with the assistance of plasma (e.g., oxygen plasma).

In some embodiments, an adhesive and/or a silicone is applied to fill pores directly and the fluidic device has a design that allows for facile adhesive infiltration and/or curing. For instance, in some embodiments, the channels in a fluidic module are positioned in opposing plastic blocks and portions of the plastic blocks surrounding the channels are also removed. This may result in the formation of a moat surrounding the channels into which an adhesive and/or a silicone can be placed. The moat may facilitate placement of the adhesive and/or the silicone such that it seals pores in the membrane surrounding the fluidic module in a manner that is particularly facile and/or reliable. FIG. 17 shows one non-limiting example of a fluidic device in which a filled moat 1408 surrounds a fluidic module 108.

The fluids flowing through the fluidic modules described herein may have a variety of suitable compositions.

In some embodiments, the fluid is suitable for performing biological processes and/or is biocompatible. For instance, in some embodiments, the fluid is sterile. As further examples, the fluid may have a pH and/or salinity that are non-toxic. In some embodiments, the fluid is non-toxic and/or lacks toxic components.

Some embodiments may comprise flowing fluids that are bodily fluids through the fluidic modules described herein and/or may relate to fluidic modules configured for use with bodily fluids. Non-limiting examples of suitable bodily fluids include blood and saliva.

In some embodiments, the fluid comprises water. The fluid may further comprise one or more additional species soluble in water (e.g., the fluid may be an aqueous solution) and/or suspendable in water (e.g., the fluid may be an aqueous suspension). As an example, in some embodiments, the fluid comprises an aqueous buffer. The aqueous buffer may be any physiological buffer, non-limiting examples of which include phosphate-buffered saline, tris-based buffers, and HEPES-based buffers. As another example, the fluid may comprise cell culture media. The cell culture media may be an aqueous composition capable of maintaining living cells.

It is also possible for the fluid to comprise one or more biological materials, including biological materials that are dissolved and/or suspended in water. For instance, some fluids may comprise cells and/or biologically-relevant molecules, examples of which include, but are not limited to: proteins, DNA, and/or RNA. When the fluid comprises cells, it may further comprise one or more species that promote cell growth, non-limiting examples of which include, but are not limited to: cell culture media, cell culture media components, and/or growth factors.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A fluidic module, comprising:
a first channel comprising a first-channel inlet;
a second channel comprising a second-channel outlet; and
a membrane positioned between the first and second channels, wherein:
the first and second channels are in fluidic communication with each other through the membrane;
the fluidic module is configured such that fluid flowing from the first-channel inlet to the second-channel outlet experiences a substantially constant pressure drop over an area of the membrane;
a dimension of the first channel perpendicular to the membrane decreases from a portion of the channel proximal to the first-channel inlet to a portion of the channel distal from the first-channel inlet; and
a dimension of the second channel perpendicular to the membrane increases from a portion of the channel distal to the second-channel outlet to a portion of the channel proximal to the second-channel outlet.

2. A method, comprising:
in a fluidic module comprising a first fluidic channel comprising a first-channel inlet, a second fluidic channel comprising a second-channel outlet, and a membrane, performing the step of:
flowing a fluid through the fluidic module from the first-channel inlet, through the first channel, through the membrane, through the second channel, and out the second-channel outlet, wherein:
the fluidic module comprises the first channel comprising the first-channel inlet, the membrane, and the second channel comprising the second-channel outlet;
the membrane is positioned between the first and second channels;
the fluid experiences a substantially constant pressure drop through the membrane over an area of the membrane;
a dimension of the first channel perpendicular to the membrane decreases from a portion of the channel proximal to the first-channel inlet to a portion of the channel distal from the first-channel inlet; and
a dimension of the second channel perpendicular to the membrane increases from a portion of the channel distal to the second-channel outlet to a portion of the channel proximal to the second-channel outlet.

3. A fluidic module, comprising:
a first channel comprising a first-channel inlet and a first-channel outlet;
a second channel comprising a second-channel outlet; and
a membrane positioned between the first and second channels, wherein:
the first and second channels are in fluidic communication with each other through the membrane;
a dimension of the first channel perpendicular to the membrane decreases from a portion of the channel proximal to the first-channel inlet to a portion of the channel distal from the first-channel inlet;
a dimension of the second channel perpendicular to the membrane increases from a portion of the channel distal to the second-channel outlet to a portion of the channel proximal to the second-channel outlet; and
the first-channel outlet is in fluidic communication with the first-channel inlet through a pathway other than the first channel.

4. A fluidic module as in claim 1, wherein the dimension of the first channel perpendicular to the membrane is a height of the first channel.

5. A fluidic module as in claim 1, wherein the dimension of the second channel perpendicular to the membrane is a depth of second channel.

6. A fluidic module as in claim 1, wherein at least a portion of the fluid does not flow across the membrane.

7. A fluidic module as in claim 1, wherein the first channel further comprises a first-channel outlet, and wherein at least a portion of the fluid flows out the first-channel outlet.

8. A fluidic module as in claim 1, wherein the membrane is configured for cell clarification, virus removal, affinity chromatography, protein A purification, ion exchange chromatography, exosome purification, hydrophobic interaction chromatography, diafiltration, and/or ultrafiltration.

9. A fluidic module as in claim 1, wherein the fluid comprises a species to which the membrane is configured to bind.

10. A fluidic module as in claim 9, wherein the membrane is configured to elute the bound species.

11. A fluidic module as in claim 1, wherein the membrane is suitable for use in flow-through mode.

12. A fluidic module as in claim 1, wherein the fluid comprises a species to which the membrane is impermeable.

13. A fluidic module as in claim 12, wherein the species deposits on the membrane when the fluid flows through the membrane.

14. A fluidic module as in claim 12, wherein an areal density of the species bound to and/or deposited on the membrane is substantially constant across the membrane.

15. A fluidic module as in claim 1, wherein a flow rate through the membrane is substantially constant across the membrane.

16. A fluidic module as in claim 1, wherein the first-channel inlet is configured to receive fluid from a bioreactor.

17. A fluidic module as in claim 1, wherein the first-channel inlet is configured to receive fluid from a first-channel outlet of a second fluidic module.

18. A fluidic module as in claim 1, wherein the second-channel outlet is configured to provide fluid to an analyzer.

19. A fluidic module as in claim 1, wherein the second-channel outlet is configured to provide fluid to a first-channel inlet of a third fluidic module.

20. A fluidic module as in claim 1, wherein the second-channel outlet is configured to provide fluid to the first-channel inlet.
